(19) United States
(12) Patent Application Publication
(10) Pub. No.: US 2026/0204505 A1
(43) Pub. Date: Jul. 16, 2026

(54) CIRCUIT BREAKER

(71) Applicant: FUJI ELECTRIC FA COMPONENTS & SYSTEMS CO., LTD., Konosu-city (JP)

(72) Inventors: Takamine HIROSE, Kounosu-city (JP); Kazuki NAGAMINE, Saitama-city (JP)

(73) Assignee: FUJI ELECTRIC FA COMPONENTS & SYSTEMS CO., LTD., Konosu-city (JP)

(21) Appl. No.: 19/404,661

(22) Filed: Dec. 1, 2025

(30) Foreign Application Priority Data
Jan. 15, 2025 (JP) 2025-005383

(51) Int. Cl. H01H 71/02; H01H 71/52

(52) U.S. Cl. CPC H01H 71/0207; H01H 71/522

(57) ABSTRACT

A circuit breaker includes a holder unit having a holder case. The holder case accommodates a pair of sliding contactors, a rotating shaft, and a pair of sliding contact pressure springs therein. The pair of sliding contactors are arranged to sandwich opposite lateral surfaces of a base end portion of a movable contactor. The rotating shaft extends through a first shaft hole formed in the base end portion of the movable contactor and second shaft holes formed in the pair of sliding contactors. Each of the pair of sliding contact pressure springs is constituted by a coil spring. The each of the pair of sliding contact pressure springs includes a reduced-diameter coiled portion wound around the outer periphery of the rotating shaft, and an increased-diameter coiled portion in contact with a portion of an outer surface of a corresponding sliding contactor which portion is radially outward of the second shaft hole thereof.

### CROSS REFERENCE TO RELATED APPLICATIONS AND INCORPORATION BY REFERENCE

This application claims benefit of priority under 35 U.S.C. § 119 based on Japanese Patent Application No. 2025-005383 filed on Jan. 15, 2025, the entire contents of which are incorporated by reference herein.

### TECHNICAL FIELD

The present invention relates to a circuit breaker.

### BACKGROUND ART

The circuit breaker includes a body case in which a main circuit contactor constituted by a fixed contactor and a movable contactor, and a holder unit pivotally supporting the movable contactor are mounted (e.g., JP 2011-154886 A, hereinafter “Patent Document 1”).

The holder unit disclosed in Patent Document 1 includes a holder case which accommodates a pair of sliding contactors, a rotating shaft, and a pair of sliding contact pressure springs. The pair of sliding contactors are arranged to sandwich the opposite lateral surfaces of a base end portion of the movable contactor. The rotating shaft extends through a shaft hole formed in the base end portion of the movable contactor and shaft holes formed in the pair of sliding contactors. The pair of sliding contact pressure springs are configured to apply a contact pressure to sliding conducting surfaces around the shaft holes of the pair of sliding contactors and the lateral surfaces of the base end portion of the movable contactor such that the sliding conducting surfaces and the lateral surfaces make close contact with each other.

### SUMMARY OF INVENTION

### Technical Problem

Importance for stable conductivity of the circuit breaker in the holder unit lies in the spring force of the sliding contact pressure spring causing the sliding conducting surface to make close contact with the lateral surface of the base end portion of the movable contact. The sliding contact pressure spring is a coil spring having a winding wire diameter uniform from one end to the other end in the axial direction of the sliding contact pressure spring. The sliding contact pressure spring has a winding wire diameter larger than the diameter of the rotating shaft and is arranged along the outer periphery of the rotating shaft. In the meantime, the shaft holes of the pair of sliding contactors are formed as holes larger than the diameter of the rotating shaft in consideration of the assemblability to the rotating shaft, looseness between components, and the like. When the sliding contactor is assembled to the rotating shaft, a gap is provided between the shaft hole and the rotating shaft. Here, when an axial end portion of the sliding contact pressure spring falls into the gap between the shaft hole of the sliding contactor and the rotating shaft due to radial movement of the sliding contact pressure spring arranged along the outer periphery of the rotating shaft, a constant spring force cannot be achieved by the sliding contact pressure spring, which may impair the stable conductivity of the circuit breaker.

It is conceivable that a component such as a washer for blocking the gap between the shaft hole of the sliding contactor and the rotating shaft is mounted on the rotating shaft to prevent the axial end portion of the sliding contact pressure spring from falling into the gap. However, assembly costs of the circuit breaker might increase due to the addition of the component such as a washer. It is also conceivable that a restriction section for restricting the radial movement of the sliding contact pressure spring is formed on the sliding contactor or the inner wall of the holder case instead of adding the component such as a washer. However, the sliding contact pressure spring requires a large winding wire diameter and increases in size due the restriction section being formed, and the holder case containing such a large sliding contact pressure spring also increases in size, which causes a problem in terms of downsizing of the circuit breaker.

In view of the above, an object of the present invention is to provide a circuit breaker which achieves a reduction in assembly costs and a reduction in size and which can achieve stable conductivity by preventing part of a sliding contact pressure spring from falling into the gap between a shaft hole of a sliding contactor and a rotating shaft.

### Solution to Problem

In order to achieve the above object, a circuit breaker according to one aspect of the present invention comprises a fixed contactor having a fixed contact point, a movable contactor having a movable contact point configured to be in and out of contact with the fixed contact point, and a holder unit rotatably supporting the movable contactor. The holder unit includes a holder case. The holder case accommodates a pair of sliding contactors, a rotating shaft, and a pair of sliding contact pressure springs. The pair of sliding contactors are arranged to sandwich opposite lateral surfaces of a base end portion of the movable contactor. The rotating shaft extends through a first shaft hole formed in the base end portion of the movable contactor and second shaft holes formed in the pair of sliding contactors. Each of the pair of sliding contact pressure springs is constituted by a coil spring configured to apply contact pressure to an outer surface of a corresponding sliding contactor out of the pair of sliding contactors such that contact pressure is applied to a contact surface between the base end portion and the corresponding sliding contactor to bring the base end portion into close contact with the corresponding sliding contactor. The each of the pair of sliding contact pressure springs includes a reduced-diameter coiled section wound around an outer periphery of the rotating shaft, and an increased-diameter coiled section in contact with a portion of the outer surface of the corresponding sliding contactor which portion is located radially outward of the second shaft hole of the corresponding sliding contactor.

### Advantageous Effects of Invention

With the circuit breaker according to the present invention, it is possible to achieve a reduction in assembly costs and a reduction in size and to achieve stable conductivity by preventing part of a sliding contact pressure spring from falling into the gap between a shaft hole of a sliding contactor and a rotating shaft.

### BRIEF DESCRIPTION OF DRAWINGS

FIG. 1 is a sectional view illustrating a circuit breaker according to the present invention.

FIG. 2 is a view illustrating a state where holder units rotatably support movable contactors for three phases, arranged in parallel.

FIG. 3 is a view illustrating components constituting a holder unit with a holder case removed.

FIG. 4 is a view illustrating disassembled constituent components of the holder unit.

FIG. 5 is a view illustrating the internal structure of the holder unit while the movable contactor is in a closed state.

FIG. 6 is a view illustrating a structure of a sliding contact pressure spring.

FIG. 7 is a view illustrating an internal structure of the holder unit while the movable contactor is performing an opening operation.

### DESCRIPTION OF EMBODIMENTS

With reference to the drawings, the following describes embodiments of the present invention. In the drawings to be referred to in the following description, identical or similar portions have identical or similar reference signs. Note that the drawings are schematic, and the relationship between thickness and flat dimension, the ratio between layer thicknesses, and the like are different from real ones. Accordingly, a specific thickness or dimension should be determined in consideration of the following description. It goes without saying that the drawings include portions having a different dimensional relationship or ratio.

Each embodiment of the present invention describes a device or a method to embody the technical idea of the present invention, and the technical idea of the present invention does not specify the quality, shape, structure, arrangement, or the like of constituent components to those described below. Various changes can be added to the technical idea of the present invention within the technical scope defined by claims described in Claims.

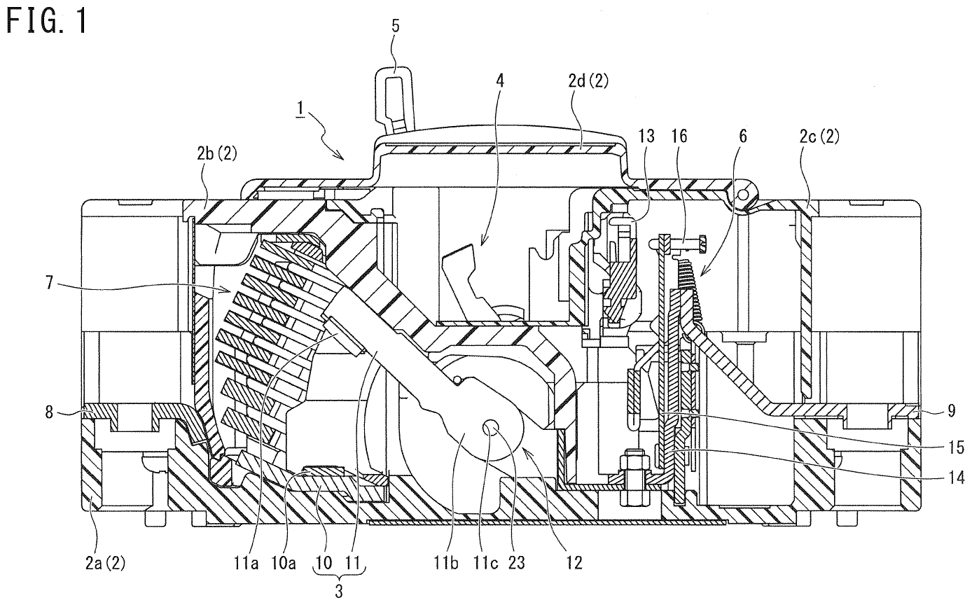

FIG. 1 is a sectional view illustrating a circuit breaker 1 for three-phase (R, S, and T) alternating current according to a first embodiment, which is connected between a power source side and a load side in a circuit, and illustrates a circuit structure of one phase among the three phases incorporated in parallel in a body case 2.

The circuit breaker 1 includes, inside the body case 2, an opening and closing mechanism 4 configured to open and close a make-and-break contact 3, an opening and closing handle 5 configured to operate the opening and closing mechanism 4, an overcurrent tripping device 6 configured to cause the opening and closing mechanism 4 to perform a tripping operation when overcurrent flows in a main circuit, and a circuit interrupter 7.

The body case 2 is configured such that a power-source-side intermediate case 2b and a load-side intermediate case 2c are assembled to a lower case 2a in an overlapping state, and a top cover 2d is assembled to the power-source-side intermediate case 2b and the load-side intermediate case 2c in an overlapping state. A power-source-side main circuit terminal 8 and a load-side main circuit terminal 9 are fixed to the lower case 2a. The make-and-break contact 3 is constituted by a fixed contactor 10 having a fixed contact point 10a, and a movable contactor 11 having a movable contact point 11a. The movable contactor 11 is rotatably supported inside a holder unit 12. Here, the movable contactor 11 includes a base end portion 11b having a shaft hole 11c. Note that a first shaft hole described in the present invention corresponds to the shaft hole 11c.

The fixed contactor 10 is connected to the power-source-side main circuit terminal 8, and the movable contactor 11 is rotatably supported by the holder unit 12 and is connected to the load-side main circuit terminal 9 via the overcurrent tripping device 6.

The opening and closing mechanism 4 is constituted with a latch mechanism including a toggle link mechanism (not illustrated) configured to connect the movable contactor 11 to the opening and closing handle 5, a latch (not illustrated), and a trip crossbar 13. When the trip crossbar 13 rotates in the counterclockwise direction, the movable contactor 11 performs an opening operation in response to a tripping operation of the opening and closing mechanism 4.

The overcurrent tripping device 6 includes a heater 14 configured to perform heating when overcurrent flows between the power-source-side main circuit terminal 8 and the load-side main circuit terminal 9, a bimetal 15 fixed to the lower portion of the heater 14, and an adjustment screw 16 which is engaged with a free end at the upper portion of the bimetal 15 and which is movable back and forth to provide a predetermined gap between the bimetal 15 and the trip crossbar 13.

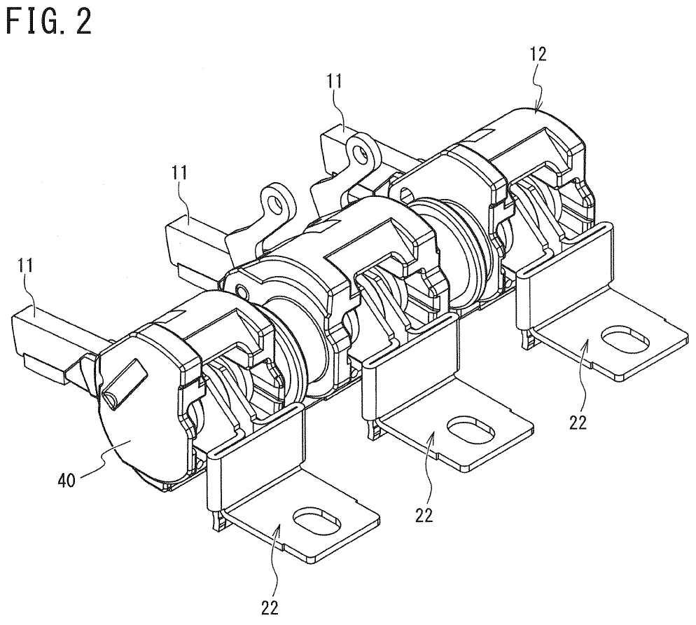

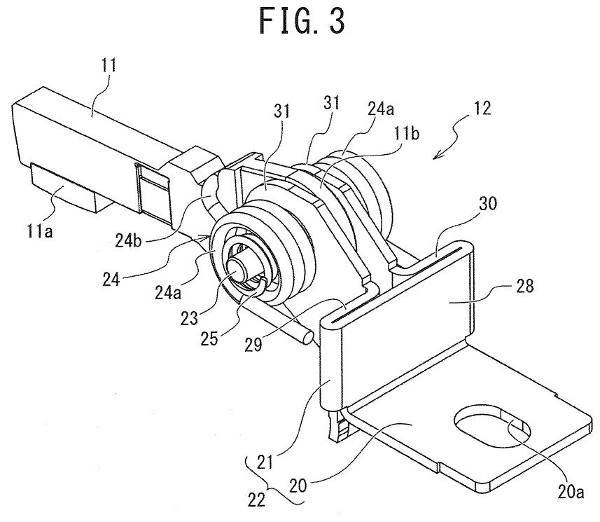

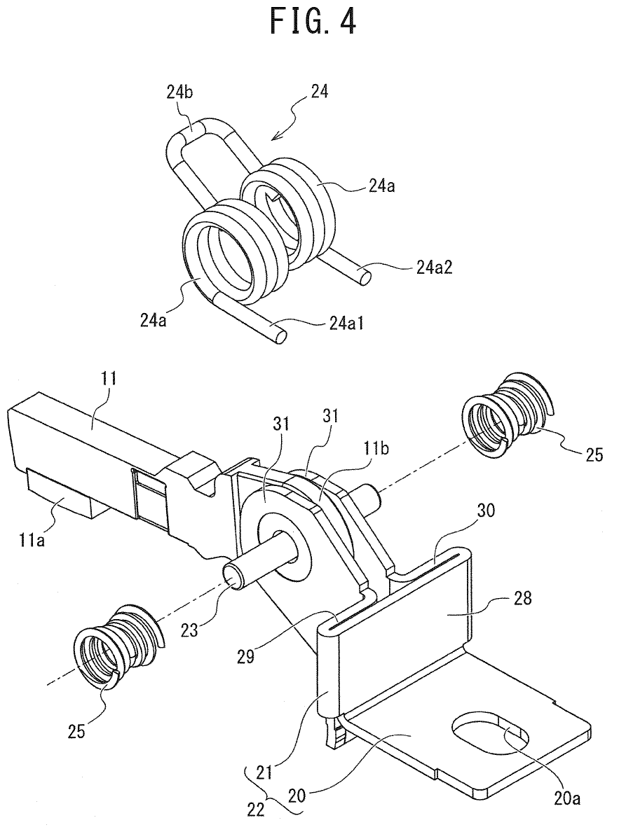

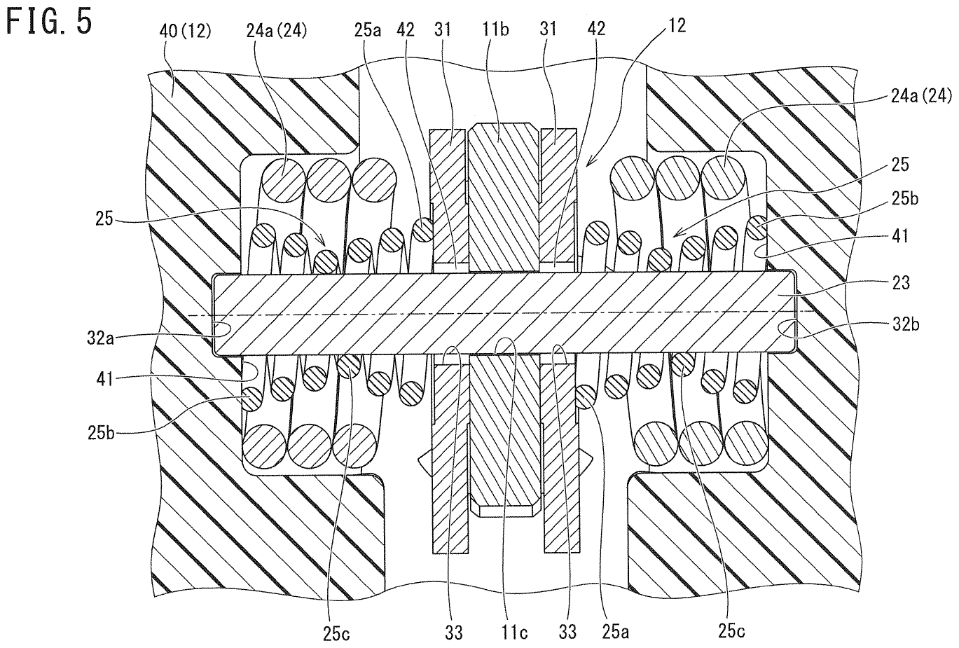

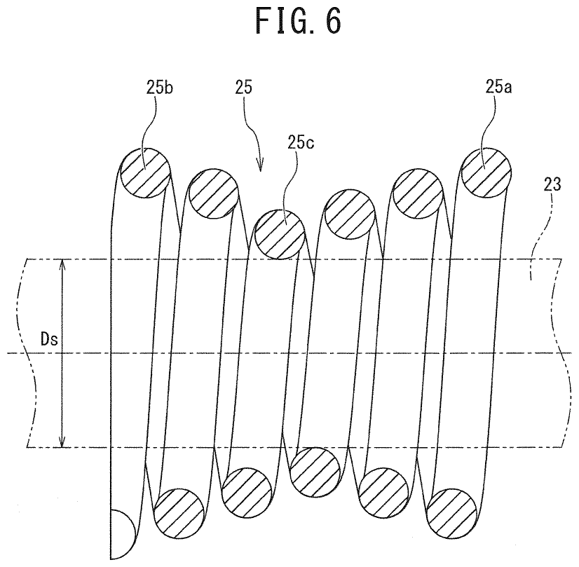

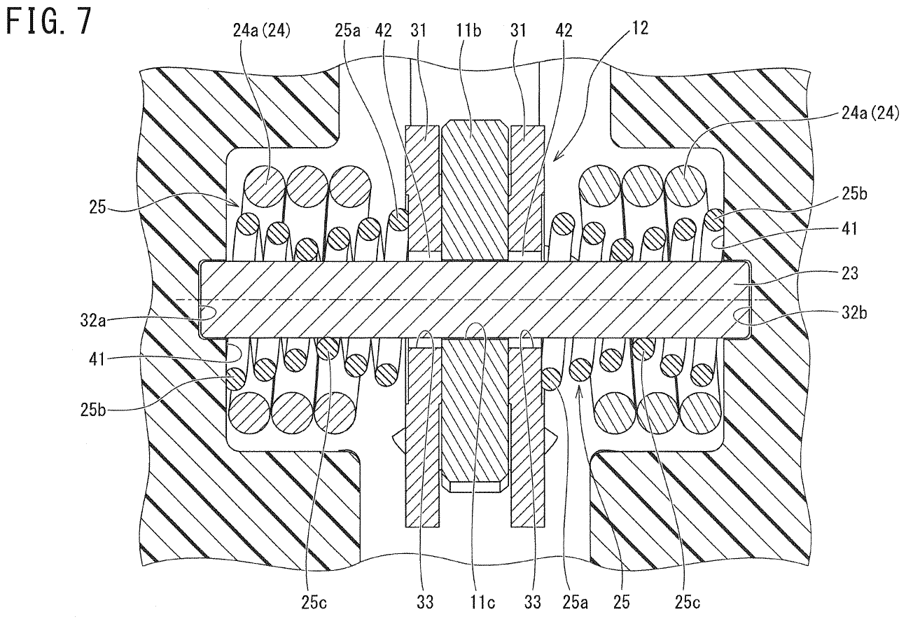

Referring now to FIGS. 2 to 7, the following will describe a structure of the holder unit 12. FIG. 2 illustrates a state where respective holder units 12 rotatably support movable contactors 11 for three phases, arranged in parallel. Reference number 40 denotes a holder case. FIG. 3 is a view illustrating components constituting the holder unit 12 with the holder case 40 removed. FIG. 4 is a view illustrating disassembled constituent components of the holder unit 12. FIG. 5 is a view illustrating an internal structure of the holder unit 12 while the movable contactor 11 is in a closed state. FIG. 6 is a view illustrating a structure of a sliding contact pressure spring 25. FIG. 7 is a view illustrating an internal structure of the holder unit 12 while the movable contactor 11 is performing an opening operation.

As illustrated in FIG. 3, the holder unit 12 includes a holder base 22, a rotating shaft 23, a movable-element pressure contact spring 24, and a pair of sliding contact pressure springs 25, which are stored in the holder case 40.

As illustrated in FIG. 4, the holder base 22 includes a support 21 formed continuously with one end side of a rectangular connection plate 20 in its longitudinal direction. The connection plate 20 has a through-hole 20a formed on the other end side of the connection plate 20 in the longitudinal direction. The support 21 is formed continuously with the one end side of the connection plate 20 in the longitudinal direction. The support 21 includes a rising edge section 28 formed continuously with the connection plate 20 to rise therefrom, a pair of coupling plates 29 and 30 extending to overlap with the rising edge section 28, and a pair of sliding contactors 31 and 31 having the same plate shape and extending in parallel to each other from the pair of coupling plates 29 and 30 toward a direction separating from the rising edge section 28. The pair of sliding contactors 31 and 31 have respective shaft holes 33 through which the rotating shaft 23 extends. The base end portion 11b of the movable contactor 11 is inserted between the pair of sliding contactors 31 and 31. It is noted that a second shaft hole described in the present invention corresponds to the shaft hole 33.

As illustrated in FIG. 5, the rotating shaft 23 is passed through the shaft hole 11c formed in the base end portion 11b and the shaft holes 33 formed in the pair of sliding contactors 31 and 31. The shaft hole 11c of the base end portion 11b is a hole having generally the same diameter as the rotating shaft 23. The shaft holes 33 of the pair of sliding contactors 31 and 31 are designed to have a hole diameter larger than the diameter of the rotating shaft 23 in consideration of assemblability, looseness between components, and the like, and a gap (an annular groove 42) is provided between each of the shaft holes 33 and the outer periphery of the rotating shaft 23. The opposite ends of the rotating shaft 23 are supported by shaft support holes 32a and 32b formed on the inner wall of the holder case 40.

As illustrated in FIG. 4, the movable-element pressure contact spring 24 is a double-torsion shaped torsion coil spring and includes a pair of contact pressure coiled sections 24a and 24a, and a coupler 24b extending between the pair of contact pressure coiled sections 24a and 24a. The coupler 24b is engaged with the movable contactor 11. The pair of contact pressure coiled sections 24a and 24a are arranged to surround the outer periphery of the rotating shaft 23. An end portion 24a1 of one contact pressure coiled section 24a and an end portion 24a2 of the other contact pressure coiled section 24a are engaged with an inner wall 41 of the holder case 40. By this, the movable-element pressure contact spring 24 is installed inside the holder case 40. In a case where the movable contactor 11 moves to an opening direction, the pair of contact pressure coiled sections 24a and 24a are tightened up (a state where the winding wire diameters of the contact pressure coiled sections 24a and 24a decrease as illustrated in FIG. 7), so that the movable-element pressure contact spring 24 applies a spring force to the movable contactor 11 in a closing direction.

As illustrated in FIGS. 3 and 4, the pair of sliding contact pressure springs 25, 25 are coil springs arranged to surround the outer periphery of the rotating shaft 23 and also arranged inside the pair of contact pressure coiled sections 24a and 24a of the movable-element pressure contact spring 24.

As illustrated in FIG. 5, the pair of sliding contact pressure springs 25 and 25 are arranged in a compressed state such that one ends 25a in the axial direction are in contact with the external walls of the pair of sliding contactors 31 and 31, and the other ends 25b in the axial direction are in contact with the inner wall 41 of the holder case 40. By this, the pair of sliding contact pressure springs 25 and 25 apply spring forces in the direction where the inner surfaces of the pair of sliding contactors 31 and 31 are closely brought into surface contact with the base end portion 11b of the movable contactor 11.

As illustrated in FIG. 6, the sliding contact pressure spring 25 includes a reduced-diameter coiled section 25c arranged in its central position in the axial direction and having a single-turn coil shape with an inside diameter having the same dimension as a diameter Ds of the rotating shaft 23. The sliding contact pressure spring 25 includes coils with winding wire diameter that increases from the reduced-diameter coiled section 25c toward one end and the other end of the sliding contact pressure spring 25 in the axial direction. Increased-diameter coiled sections (hereinafter referred to as increased-diameter coiled sections 25a and 25b) with a winding wire diameter larger than that of the reduced-diameter coiled sections 25c are formed in the one end 25a and the other end 25b of the sliding contact pressure spring 25 in the axial direction.

The increased-diameter coiled sections 25a and 25b have an inside diameter designed to a value larger than the outer peripheral edges of the shaft holes 33 of the pair of sliding contactors 31 and 31. The increased-diameter coiled sections 25a and 25b have an outside diameter designed to a value smaller than the inside diameter of the contact pressure coiled sections 24a and 24a tightened up due to the opening operation of the movable contactor 11 illustrated in FIG. 7.

With the holder unit 12 of the circuit breaker 1 in the above configuration, the pair of sliding contact pressure springs 25 and 25 apply spring forces in the direction where the inner surfaces of the pair of sliding contactors 31 and 31 are closely brought into surface contact with the opposite lateral surfaces of the base end portion 11b of the movable contactor 11. At this time, as illustrated in FIG. 5, as the reduced-diameter coiled sections 25c of the pair of sliding contact pressure springs 25 and 25 are wound around the outer periphery of the rotating shaft 23, the pair of sliding contactors 31 and 31 are restricted from moving in the radial direction (the direction perpendicular to the axis of the rotating shaft 23). As radial movements of the pair of sliding contact pressure springs 25 and 25 are restricted, there is no risk that the end portions (the increased-diameter coiled sections 25a) of the pair of sliding contact pressure springs 25 and 25 fall into the annular grooves 42, so that the inner surfaces of the pair of sliding contactors 31 and 31 can be properly brought into close contact with the opposite lateral surfaces of the base end portion 11b of the movable contactor 11 by the spring forces defined by the pair of sliding contact pressure springs 25 and 25. Therefore, this allows the circuit breaker 1 to have stable conductivity.

Besides, the increased-diameter coiled sections 25a of the pair of sliding contact pressure springs 25 and 25 which increased-diameter coiled sections 25a have a winding wire diameter larger than that of the reduced-diameter coiled sections 25c are in contact with the outer surfaces of the pair of sliding contactors 31 and 31, and therefore, the inner surfaces of the pair of sliding contactors 31 and 31 are in contact with the opposite lateral surfaces of the base end portion 11b with a large conductive area, thereby making it possible to further enhance the stable conductivity.

In addition, the increased-diameter coiled sections 25a of the pair of sliding contact pressure springs 25 and 25 have an outside diameter set to a value smaller than the inside diameter of the contact pressure coiled sections 24a and 24a of the movable-element pressure contact spring 24 which contact pressure coiled sections 24a and 24a are tightened up during the opening operation of the movable contactor 11. Thus, this does not affect the function of the pair of sliding contact pressure springs 25 and 25 to apply spring restoring force to the movable contactor 11 in the closing direction.

Besides, the sliding contact pressure spring 25 has a shape in which the reduced-diameter coiled section 25c is arranged in the central portion in the axial direction, and the winding wire diameter gradually increases from the reduced-diameter coiled section 25c toward one end and the other end of the sliding contact pressure spring 25 in the axial direction to form the increased-diameter coiled sections 25a and 25b having the same winding wire diameter at the one end and the other end in the axial direction. This allows the sliding contact pressure spring 25 to be compressed without eccentricity, thereby making it possible to generate uniform spring force.

Unlike the related art, no additional component is required, and the sliding contact pressure spring 25 and the holder case 40 are not large components. This makes it possible to achieve a reduction in assembly costs and downsizing of the circuit breaker 1.

### REFERENCE SIGNS LIST

1: circuit breaker
2: body case
3: make-and-break contact
4: opening and closing mechanism
5: opening and closing handle
6: overcurrent tripping device
7: circuit interrupter
8: power-source-side main circuit terminal
9: load-side main circuit terminal
10: fixed contactor
10a: fixed contact point
11: movable contactor
11a: movable contact point
11b: base end portion
11c: shaft hole
12: holder unit
13: trip crossbar
14: heater
15: bimetal
16: adjustment screw
20: connection plate
20a: through-hole
21: support
22: holder base
23: rotating shaft
24: movable-element pressure contact spring
24a: contact pressure coiled section
24b: coupler
24a1, 24a2: end portion of contact pressure coiled section
25: sliding contact pressure spring
25a, 25b: increased-diameter coiled section
25c: reduced-diameter coiled section
28: rising edge section
29, 30: coupling plate
31: sliding contactor
33: shaft hole
32a, 32b: shaft support hole
40: holder case
41: inner wall of holder case
42: annular groove

1. A circuit breaker comprising:
a fixed contactor having a fixed contact point;
a movable contactor having a movable contact point configured to be in and out of contact with the fixed contact point; and
a holder unit configured to rotatably support the movable contactor,
wherein the holder unit includes a holder case which accommodates a pair of sliding contactors, a rotating shaft, and a pair of sliding contact pressure springs, the pair of sliding contactors being arranged to sandwich opposite lateral surfaces of a base end portion of the movable contactor, the rotating shaft extending through a first shaft hole formed in the base end portion of the movable contactor and second shaft holes formed in the pair of sliding contactors, each of the pair of sliding contact pressure springs being constituted by a coil spring configured to apply contact pressure to an outer surface of a corresponding sliding contactor out of the pair of sliding contactors such that contact pressure is applied to a contact surface between the base end portion and the corresponding sliding contactor to bring the base end portion into close contact with the corresponding sliding contactor, and
wherein the each of the pair of sliding contact pressure springs includes a reduced-diameter coiled section wound around an outer periphery of the rotating shaft, and an increased-diameter coiled section in contact with a portion of the outer surface of the corresponding sliding contactor which portion is located radially outward of the second shaft hole of the corresponding sliding contactor.

2. The circuit breaker according to claim 1, wherein:
the reduced-diameter coiled section is formed at an axially central position of the each of the pair of the sliding contact pressure springs; and
the increased-diameter coiled section includes increased-diameter coiled sections formed in axially opposite end portions of the each of the pair of the sliding contact pressure springs.

3. The circuit breaker according to claim 1, wherein:
the holder unit includes a movable-element pressure contact spring stored in the holder case and configured to apply spring force in a closing direction to the movable contactor rotating in an opening direction;
the movable-element pressure contact spring includes contact pressure coiled sections arranged coaxially along respective outer peripheries of the pair of sliding contact pressure springs; and
the increased-diameter coiled section has an outside diameter set to be smaller than an inside diameter of the contact pressure coiled sections tightened due to the rotation of the movable contactor in the opening direction.
